(19) United States
(12) Patent Application Publication
(10) Pub. No.: US 2011/0004325 A1
(43) Pub. Date: Jan. 6, 2011

(54) System and Method for Consumer Electronic Device Packaging and Presentation

(75) Inventor: Sam Ayal, Brooklyn, NY (US)

Correspondence Address: ARENT FOX LLP, 1675 BROADWAY, NEW YORK, NY, 10019, US

(73) Assignee: Southern Telecom Inc.

(21) Appl. No.: 12/497,004

(22) Filed: Jul. 2, 2009

(51) Int. Cl. G06F 17/00; B65B 5/04

(52) U.S. Cl. 700/17; 53/396; 700/94

(57) ABSTRACT

Disclosed herein are novel systems and methods for demonstrating functionality of a consumer electronic device contained in a point-of-sale package. A consumer electronic device includes an external switch, such as a pushbutton switch, detachably connected via a cable to the device's communication interface, such as its USB port. The switch may be partially exposed through the point-of-sale package, so that a consumer can activate the electronic device in a “demo mode”. In this mode, the device may be configured to play a multimedia demo clip or other presentation. When the electronic device is purchased and removed from the package by the consumer, the cable and the switch may be disconnected from the device and discarded. The consumer may then activate the device in a “normal mode” using the device's power-on switch.

### TECHNICAL FIELD

The present disclosure relates generally to the field of consumer electronics and, more specifically, to the systems and methods for demonstrating functionality of a consumer electronic device contained in a point-of-sale package.

### BACKGROUND

Consumer electronic devices have become ubiquitous in the modern society. These devices include cell phones, portable multimedia players and gaming devices, digital cameras and camcorders, GPS navigation systems, laptop computers or other types of portable electronic devices. The demand for these products is fueled by the abundance of digital media, such as music, video, photos and books, and the widespread wireless Internet connectivity, which provides easy access to this digital media on the electronic device. Driven by this demand, electronics manufacturers constantly develop new products having advanced features, greater memory, higher image resolution, extended connectivity, wider interoperability, smaller form factor and longer battery life.

However, to stay competitive in the oversaturated consumer electronics market, device manufacturers must effectively market their products to the consumers. This becomes even more challenging based on the wide availability and affordability of consumer electronic devices. Consumers thus often make their purchase decisions at the point of sale, where they are typically exposed to a multitude of competing products. Therefore, to distinguish their products from those of their competitors, manufacturers go to great lengths to provide esthetic design to their products, distinctive packaging and exhaustive description of their products' functions and specifications on the point-of-sale packaging.

Another effective marketing technique is to allow a demonstration of the product's functions from within the point-of-sale package. To this end, some products have a “try-me” or “demo” button, which, when pressed by the consumer, temporarily activates the product to play a multimedia presentation of the product's functions or the like. However, adding an extra button to the electronic device may be impractical because the button will not be used once the product is actually purchased; it may be impossible to use due to the small form factor of the device; or it may adversely affect the aesthetics of the device, which is often as important to the consumer as the functions of the device itself.

Accordingly, there is a need for a mechanism for providing a demonstration of the functions of a consumer electronic device contained in a point-of-sale package.

### SUMMARY

Disclosed herein are novel systems and methods for demonstrating functionality of a consumer electronic device contained in a point-of-sale package. The consumer electronic device and methods of operation thereof provide an effective way for demonstrating functionality of the packaged consumer electronic device without making significant internal alterations and, more importantly, without any external alterations to the device, which may adversely affect the appearance of the device. In particular, an inexpensive external switch may be attached to the existing communication interface of the device, such as its USB port or other interface typically used for recharging the device and/or transmitting/receiving data. The switch may be exposed through the point-of-sale package and activated by a consumer to power on the device in a demo mode. When the device is purchased and the point-of-sale package is removed by the consumer, the external switch may be disconnected from the device and discarded. The consumer may then activate the device in a “normal mode” using a power-on switch.

In one example embodiment, a packaged consumer electronic device includes a processor operable to activate the device in different operating modes, including at least a normal mode and a demo mode. The device further includes a control circuit coupled to the processor for generating a first control signal in response to which the processor activates the normal mode and a second control signal in response to which the processor activates the demo mode. The device further includes a power-on switch coupled to the control circuit for enabling the control circuit to generate the first control signal and a communication interface coupled to the control circuit. In addition, the device includes an external switch detachably connected to the communication interface of the device for enabling the control circuit to generate the second control signal. The point of sale package enclosing the device includes at least one opening for at least partially exposing the external switch to allow a consumer to activate the device in the demo mode.

In another example embodiment, a method for operating a consumer electronic device in multiple modes comprises generating a first control signal through a first signal path of a control circuit in response to activation of a power switch of the consumer electronic device. The method further includes activating the consumer electronic device in a normal operating mode in response to detecting the first control signal by a processor of the consumer electronic device. The method further includes generating a second control signal through a second signal path of the control circuit in response to activation of an external switch of the consumer electronic device. The method further includes activating the consumer electronic device in a demo operating mode in response to detecting the second control signal by the processor of the consumer electronic device with the first and second control signals having different power levels.

### BRIEF DESCRIPTION OF THE DRAWINGS

The accompanying drawings, which are incorporated into and constitute a part of this specification, illustrate one or more example embodiments of the invention and, together with the detailed description serve to explain the principles and implementations of the embodiments.

In the drawings:

FIG. 1 illustrates a block diagram of a packaged consumer electronic device in accordance with one example embodiment.

FIG. 2 illustrates a flow diagram of a method of multi-mode operation of a consumer electronic device in accordance with one example embodiment.

FIG. 3 illustrates a block diagram of a consumer electronic device in accordance with one example embodiment.

FIG. 4 illustrates flow diagrams of two modes of operation of a consumer electronic device in accordance with another example embodiment.

FIG. 5 illustrates a circuit diagram of a consumer electronic device in accordance with one example embodiment.

### DESCRIPTION OF EXAMPLE EMBODIMENTS

Example embodiments of systems and methods for demonstrating functionality of a consumer electronic device contained in a point-of-sale package are disclosed herein. Those of ordinary skill in the art will realize that the following description is illustrative only and is not intended to be in any way limiting. Other embodiments will readily suggest themselves to those of ordinary skill in the art of electronics having the benefit of this disclosure. Reference will now be made in detail to implementations of the example embodiments as illustrated in the accompanying drawings. The same reference indicators will be used to the extent possible throughout the drawings and the following description to refer to the same or like items.

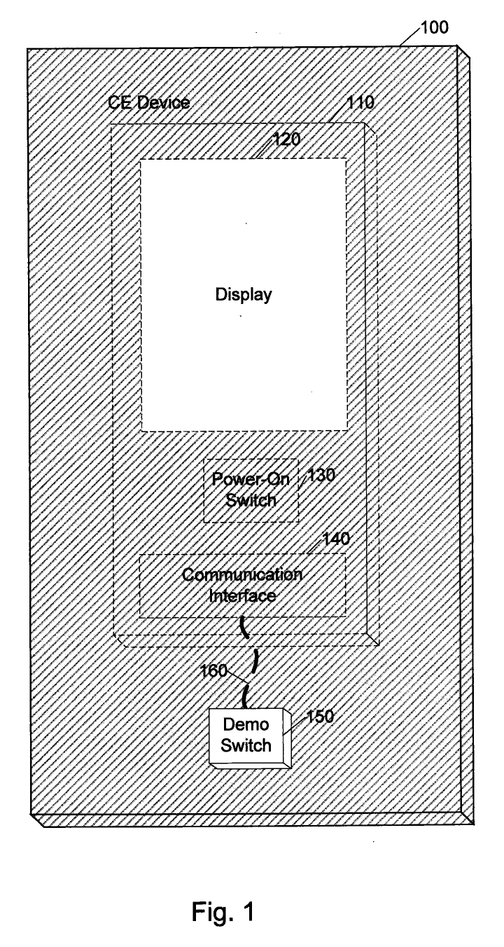

FIG. 1 illustrates one example embodiment of a point-of-sale package 100 containing a consumer electronic (CE) device 110. The consumer electronic device 110 may include, but is not limited to, a cell phone, a personal digital assistant, a portable multimedia player, such as MP3 or MP4 player, a portable gaming device, a digital camera or camcorder, a GPS navigation system, a laptop computer or other types of portable electronic devices. As depicted, the CE device 110 may by fully or partially enclosed in the point-of-sale package 100. The package 100 may be constructed of a molded plastic, paper, fiberboard or any combination of these or other materials suitable for securely housing the consumer electronic device 100. The packaged consumer electronic device 110 may be displayed for sale to consumers in a retail or any other type of sales establishment.

In one example embodiment, the package 100 and the CE device 110 may be configured to allow a consumer to activate the device in a demo mode, without removing the device from the package, in order to evaluate features and functionality of the device before purchasing it. To that end, a demo switch 150 (also referred to herein as an external switch) may be provided within the package 100 and be connected to a communication interface 140 of the CE device 110 via a cable 160. The switch 150 may include an electromechanical switch, such as a pushbutton switch, a toggle switch, a piezoelectric switch or the like. As depicted, the switch 150 may be at least partially exposed through the package 100, so that consumer can activate the switch to power up the device in the demo mode. Alternatively, the switch 160 may be covered by a flexible membrane of the package 100, or the like, and activated by the consumer pressing the membrane.

In another example embodiment, the CE device 110 is configured to operate in a normal mode. In particular, when the device is purchased and the point-of-sale package is removed by the consumer, the external switch 150 and the cable 160 may be disconnected from the device and discarded. The consumer may then power-on the CE device 110 in the normal operating mode by activating a power-on switch 130. The switch 130 may be an electromechanical switch, such as a pushbutton switch, a toggle switch, a piezoelectric switch or the like. Unlike the demo switch 150, which is exposed through the package 100, the power-on switch 130 may be covered by the package to prevent accidental activation thereof by a consumer while the device is still in the package. Thus, the consumer may activate a packaged CE device 110 in the demo mode to view a demonstration of device's functionality and when the package is removed the user may activate the device in the normal mode and use all of the device's functions.

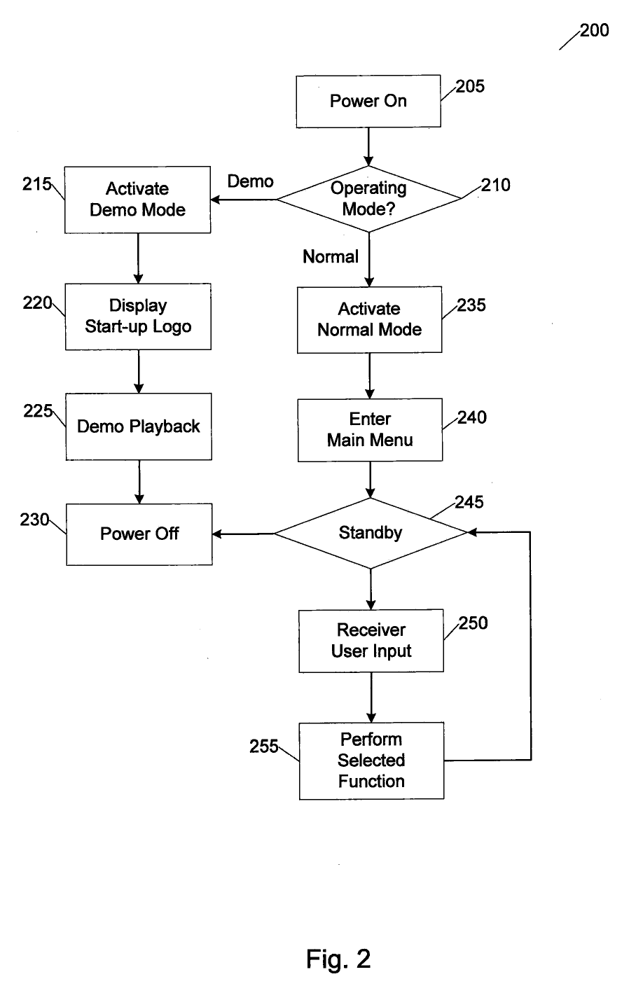

FIG. 2 illustrates a method for multi-mode operation of the CE device 110 in accordance with one example embodiment. At step 205, the consumer powers-up the device by activating either the demo switch 150 or the power-on switch 130. Once powered, the device determines at step 210 which operating mode was selected by the consumer. If the demo switch was activated, the device at step 215 activates in the demo operating mode. In this mode, the device may display a start-up logo at step 220 and playback a demo presentation at step 225. The demo presentation may include, for example, a brief audio multimedia clip or other presentation of the device's features and functions. The CE device may then automatically power off at step 230.

If the consumer activates the power-on switch, the device activates at step 235 in the normal operating mode. In this mode, the CE device may display at step 240 a menu of various functions of the device, such as, make phone calls, send e-mails or text messages, play music, take photos, record videos, play games, search for directions, browse the Internet, run word processing or other applications or other functions common to consumer electronic devices. The CE device then goes into the standby mode at step 245 until a user input is detected. When the user input is received at step 250, the CE device performs at step 255 the user-selected function. The CE device then again goes into standby mode at step 245. If no new user input is received within a predetermined period of time, e.g., five minutes, the device may automatically power off.

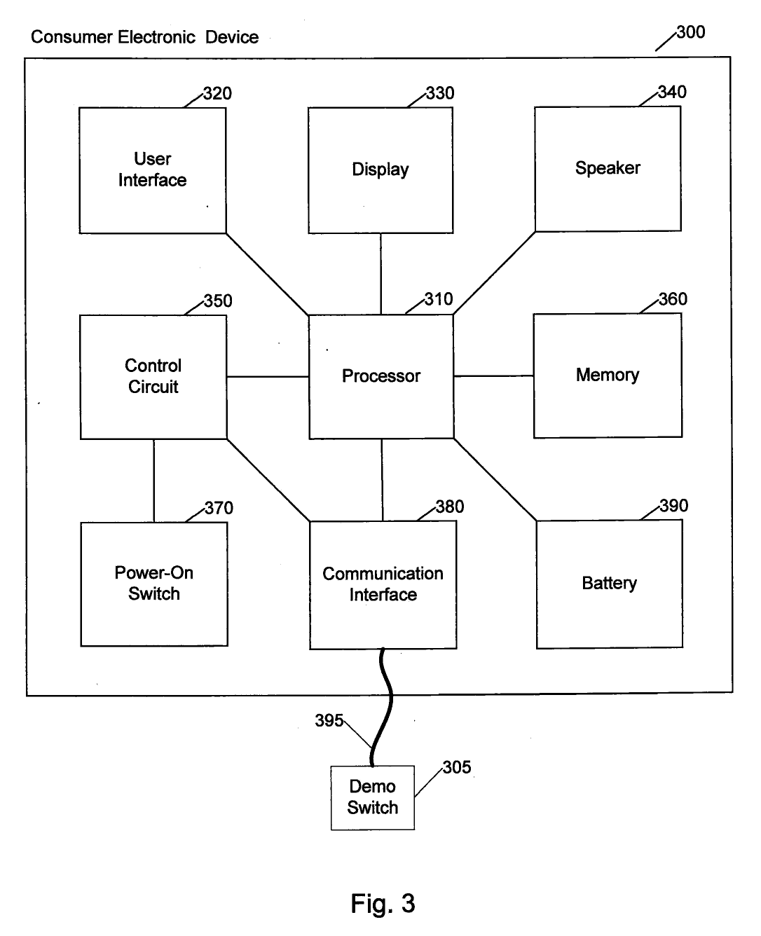

FIG. 3 illustrates a sample configuration of a consumer electronic device in accordance with one example embodiment. The CE device 300 includes a processor 310 that controls operation of the device, including selection and activation of the normal and demo modes. The processor 310 may include a general- or special-purpose processor, such as a microprocessor, a digital signal processor (DSP), a microcontroller, an application-specific integrated circuit (ASIC), a programmable gate array (PGA) or the like. The CE device 300 also includes a user interface, such as a keyboard, pushbuttons, a scrollwheel, a trackball, a touch screen, and the like. The device may also include a display 330, such as a liquid crystal display (LCD), organic electroluminescent (OEL) or the like. The display 330 may be a touch screen display. The device may also include an internal speaker 340 or an audio jack for connecting to external speakers or headphones.

In one example embodiment, the CE device 300 further includes a memory 360 for storing multimedia files, such as photos, audio and video, contact information, application and program data and other information. The memory 360 may include a non-volatile memory medium, such as solid state, magnetic or optical drive, EPROM, EEPROM or Flash memory. The memory 360 may also include temporary memory, such as static random access memory (SRAM), dynamic RAM (DRAM) and other types of volatile memory. The CE device 300 may also include a communication interface 380, such as a mini-universal serial bus (USB) port or other interface typically used for recharging the device and/or transmitting/receiving data from external sources. The device also includes a rechargeable battery 390, such a lithium battery or the like.

To facilitate selection of different operating modes, the CE device 300 may further include a demo switch 305, a power-on switch 370 and a control circuit 350 in accordance with one example embodiment. As depicted, the control circuit 350 may be directly coupled to the power-on switch 370 and to the demo switch 305 via the communication interface 380 and a cable 395. The control circuit 350 is also coupled to the processor 310. The circuit 350 may include a plurality of discrete or integrated electrical components, such as resistors, transistors, capacitors and inductors. In general, the control circuit is operable to generate and transmit two different control signals to the processor 310 in response to the user activating either the power-on switch 370 or the demo switch 305. These control signals may have different power levels. The processor 310 detects the power level of the control signal, determines the corresponding operating mode, and activates the CE device 300 in the appropriate operating mode.

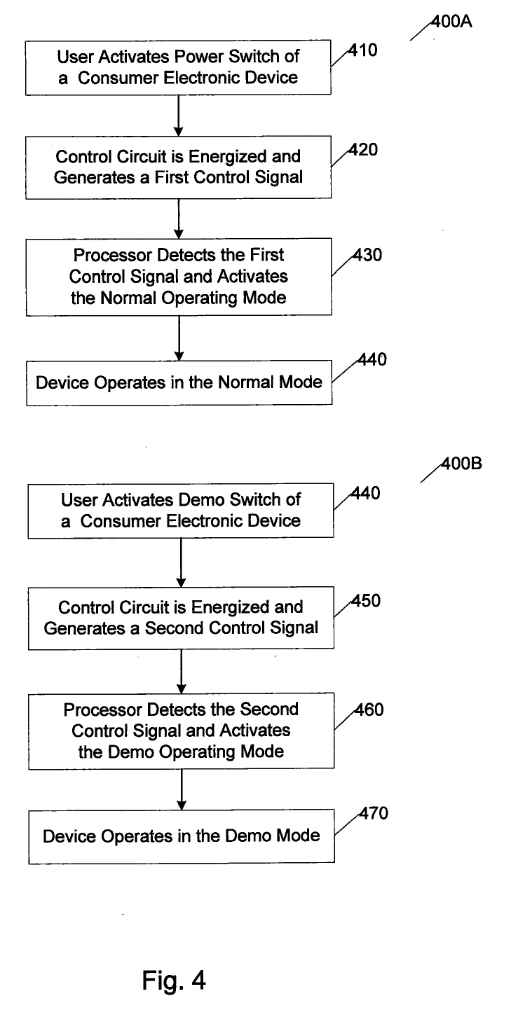

FIG. 4 illustrates two modes of operation of the control circuit in accordance with one example embodiment. Diagram 400A illustrates operation of the control circuit in the normal operating mode. When the user activates at step 410 the power-on switch of the CE device, the control circuit is energized and generates a first control signal at step 420. The processor detects the first control signal and activates the device in the normal operating mode at step 430. In the normal operating mode, the device operates at step 440 as described above with reference to flow diagram 200. Diagram 400B illustrates operation of the control circuit in the demo mode. When the user activates at step 440 the demo switch of the CE device, the control circuit is energized and generates a second control signal at step 450. The processor detects the second control signal and activates the device in the demo mode at step 460. In the demo mode, the device operates at step 470 as described above with reference to flow diagram 200.

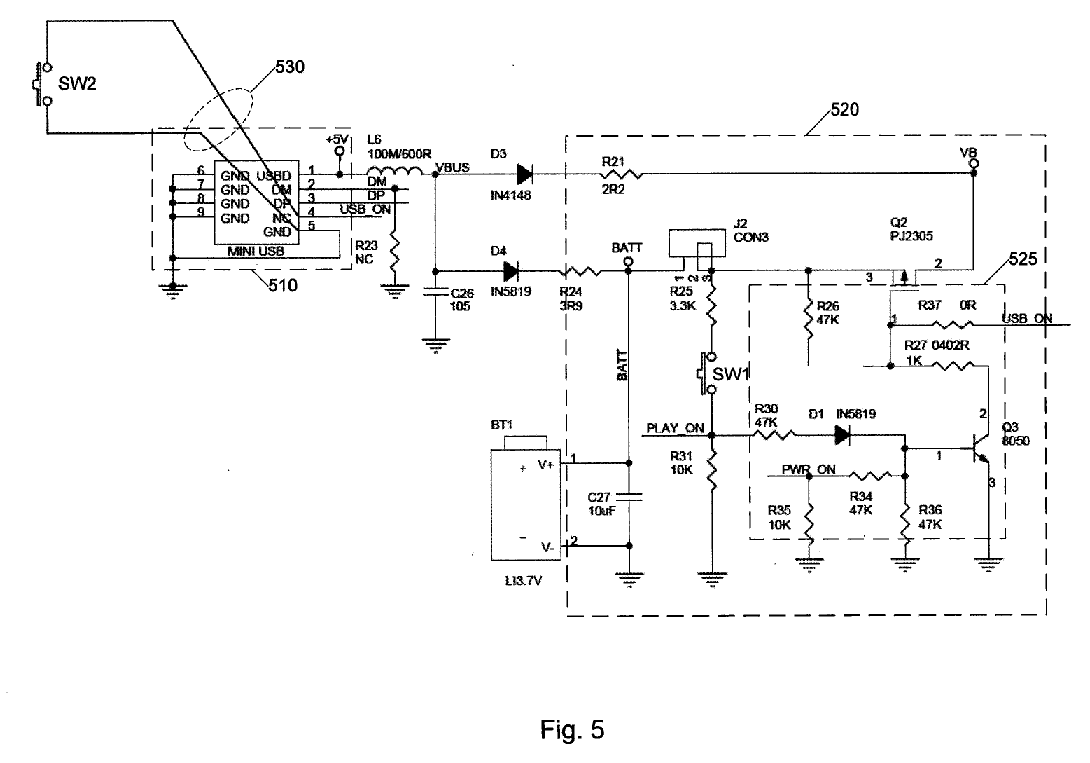

FIG. 5 illustrates one exemplary configuration of circuit components of the consumer electronic device that facilitate a multi-mode operation thereof. As depicted, these components include a power switch SW1, a demo switch SW2, a communication interface 510 and a control circuit 520. When the switches SW1 and SW2 are opened, the control circuit 520 is opened and disconnected from a battery BT1, so that CE device is powered off. When the power-on switch SW1 is closed by the user, the “play_on” node is short connected with battery anode via resistor R25, which creates a low impedance signal path through the control circuit 520. This energizes the control circuit 520 and creates a high power signal, e.g., greater than 0.7V, at the play_on node, which is connected to the processor of the CE device. The processor detects this high power signal and, in response, activates the CE device in the normal operating mode.

Alternatively, when the demo switch SW2 is closed by the user, the NC terminal (pin 4) of the mini USB interface 510 is short connected to the GND terminal (pin 5) via a cable 530, which may be a twisted wire cable or the like. The play_on node of control circuit 520 is then connected with the GND via resistor R31 and with the battery anode via resistor network 525, which creates a high impedance signal path through the control circuit 520. This energizes the control circuit 520 and creates a low power signal, e.g., less than 0.3V, at the play_on node, which is connected to the processor of the CE device. The processor detects this low power signal and, in response, activates the CE device in the demo operating mode. In this manner, the consumer electronic device may alternatively operate in the demo and normal operating modes.

The disclosed systems and methods provide an effective way for demonstrating functionality of the device contained in a point-of-sale package without making significant internal alterations and, more importantly, without any external alterations to the consumer electronic device, which may adversely affect appearance of the device. All electrical and electronic components used in the disclosed example embodiments are relatively inexpensive and can be readily obtained and assembled by those of ordinary skill in the art of electronics having the benefit of this disclosure into the operational products. It should be further noted that the circuit diagrams are merely illustrative and do not represent the preferred modes of practicing the invention. Those of ordinary skill in the art may substitute individual circuit elements or groups thereof with their functional equivalents without departing from the spirit of the invention.

The various embodiments of methods for operating a consumer electronic device in multiple operating modes may be implemented using hardware, software, firmware or a combination thereof. Where a method comprising a series of process steps is implemented by a processor and those process steps can be stored as a series of instructions readable by the processor, they may be stored on a tangible medium such as computer memory devices (e.g., ROM, PROM and EEPROM, Flash memory and the like), magnetic storage medium (e.g., tape, magnetic disk drive and the like) and other types of program memory. Moreover, although example embodiments of the systems and methods have been described herein in connection with consumer electronic devices. The principles set forth herein are not limited to consumer electronic devices and may be readily implemented and applies without undue experimentation by those of ordinary skill in the art having benefit of this disclosure in other types of electronic devices.

In the interest of clarity, not all of the routine features of the implementations described herein are shown and described. It will be appreciated that in the development of any such actual implementations, numerous implementation-specific decisions must be made in order to achieve the developer's specific goals, such as compliance with the hardware- or software-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art of electronics having the benefit of this disclosure.

Furthermore, it is to be understood that the phraseology or terminology used herein is for the purpose of description and not of limitation, such that the terminology or phraseology of the present specification is to be interpreted by those of ordinary skill in the art in light of the teachings and guidance presented herein, in combination with the knowledge of those of ordinary skill in the art. Moreover, it is not intended for any term in the specification or claims to be ascribed an uncommon or special meaning unless explicitly set forth as such. The various example embodiments disclosed herein encompass present and future known equivalents to the known components referred to herein by way of illustration. Moreover, while embodiments and applications have been shown and described, it would be apparent to those of ordinary skill in the art having the benefit of this disclosure that many more modifications than mentioned above are possible without departing from the inventive concepts disclosed herein.

What is claimed is:

1. A packaged consumer electronic device comprising:
a consumer electronic device including
a processor operable to activate the consumer electronic device in different operating modes, including at least a normal mode and a demo mode;
a control circuit coupled to the processor for generating a first control signal in response to which the processor activates the normal mode and a second control signal in response to which the processor activates the demo mode;
a power switch coupled to the control circuit for enabling the control circuit to generate the first control signal; and
a communication interface coupled to the control circuit;
an external switch detachably connected to the communication interface for enabling the control circuit to generate the second control signal; and
a package at least partially enclosing the consumer electronic device, the package including at least one opening for at least partially exposing the external switch for allowing a consumer to activate the packaged device in the demo mode.

2. The device of claim 1, wherein the first control signal and second control signal have different power levels and the processor is operable to distinguish the power level of the first control signal and the power level of the second control signal.

3. The device of claim 1, wherein activation of the power switch causes formation of a first signal path through the control circuit to the processor and activation of the external switch causes formation of a second signal path through the control circuit to the processor, wherein the first signal path has lower impedance than the second signal path.

4. The device of claim 1, wherein the power switch and the external switch include one of a pushbutton switch, a toggle switch, and a piezoelectric switch.

5. The device of claim 1, wherein the communication interface is a USB interface.

6. The device of claim 5, wherein the external switch is connected to the communication interface via a cable having a USB connector.

7. The device of claim 1, wherein, in the demo mode, the consumer electronic device is configured to power on, play a multimedia demo file and power off.

8. The device of claim 1, further comprising:
a memory for storing multimedia files including a multimedia demo clip;
a battery for powering the device in the demo mode and the normal mode;
a display for reproducing video of the multimedia demo clip; and
a speaker for reproducing audio of the multimedia demo clip.

9. A method for operation of a consumer electronic device, the method comprising:
generating a first control signal through a first signal path of a control circuit in response to activation of a power switch of the consumer electronic device;
activating the consumer electronic device in a normal operating mode in response to detecting the first control signal by a processor of the consumer electronic device; and
generating a second control signal through a second signal path of the control circuit in response to activation of an external switch of the consumer electronic device; and
activating the consumer electronic device in a demo operating mode in response to detecting the second control signal by the processor of the consumer electronic device, wherein the first and second control signals have different power levels.

10. The method of claim 10, wherein the first signal path and second signal path have different impedance.

11. A consumer electronic device comprising:
a processor operable to activate the consumer electronic device in different operating modes, including at least a normal mode and a demo mode;
a control circuit coupled to the processor for generating a first control signal in response to which the processor activates the normal mode and a second control signal in response to which the processor activates the demo mode;
a power switch coupled to the control circuit for enabling the control circuit to generate the first control signal;
a communication interface coupled to the control circuit; and
an external switch detachably connected to the communication interface for enabling the control circuit to generate the second control signal.

12. The device of claim 11, further includes a package for at least partially enclosing the consumer electronic device, the package including at least one opening for at least partially exposing the external switch for allowing a consumer to activate the packaged device in the demo mode.

13. The device of claim 11, wherein the first control signal and second control signal have different power levels and the processor is operable to distinguish the power level of the first control signal and the power level of the second control signal.

14. The device of claim 11, wherein activation of the power switch causes formation of a first signal path through the control circuit to the processor and activation of the external switch causes formation of a second signal path through the control circuit to the processor, wherein the first signal path has lower impedance than the second signal path.

15. The device of claim 11, wherein the power switch and the external switch include one of a pushbutton switch, a toggle switch, and a piezoelectric switch.

16. The device of claim 11, wherein the communication interface is a USB interface.

17. The device of claim 16, wherein the external switch is connected to the communication interface via a cable having a USB connector.

18. The device of claim 11, wherein, in the demo mode, the consumer electronic device is configured to power on, play a multimedia demo file and power off.

19. The device of claim 11, further comprising:
a memory for storing multimedia files including a multimedia demo clip;
a batter for powering the device in the demo mode and the normal mode;
a display for reproducing video of the multimedia demo clip; and
a speaker for reproducing audio of the multimedia demo clip.

20. A method for packaging a consumer electronic device, the method comprising:
providing a consumer electronic device including:
a processor operable to activate the consumer electronic device in different operating modes, including at least a normal mode and a demo mode;
a control circuit coupled to the processor for generating a first control signal in response to which the processor activates the normal mode and a second control signal in response to which the processor activates the demo mode;
a power switch coupled to the control circuit for enabling the control circuit to generate the first control signal;
a communication interface coupled to the control circuit;
detachably connecting via a cable an external switch to the communication interface for enabling the control circuit to generate the second control signal; and
enclosing the consumer electronic device, the cable and the external switch into a point-of-sale package, wherein the package includes at least one opening for at least partially exposing the external switch for activating the device in the demo mode.
